(19) United States
(12) Patent Application Publication
(10) Pub. No.: US 2008/0094536 A1
(43) Pub. Date: Apr. 24, 2008

(54) METHOD OF MANUFACTURING LIGHT SOURCE UNIT, BACKLIGHT UNIT INCLUDING THE LIGHT SOURCE UNIT, AND LIQUID CRYSTAL DISPLAY INCLUDING THE BACKLIGHT UNIT

(76) Inventor: Dae Seop Kim, Anseong-Si (KR)

Correspondence Address: F. CHAU & ASSOCIATES, LLC, 130 WOODBURY ROAD, WOODBURY, NY, 11797, US

(21) Appl. No.: 11/875,347

(22) Filed: Oct. 19, 2007

(30) Foreign Application Priority Data
Oct. 20, 2006 (KR) 10-2006-0102148

(51) Int. Cl. G02F 1/13357; F21V 8/00; H01J 9/00

(52) U.S. Cl. 349/58; 362/612; 445/23

(57) ABSTRACT

A backlight unit includes a printed circuit board, and light emitting diodes mounted on a first surface of the printed circuit board, wherein the printed circuit board includes a conductive plate provided on a second surface of the printed circuit board, and a plurality of conductive particles are provided on the conductive plate.

### CROSS-REFERENCE TO RELATED APPLICATION

This application claims priority to Korean Patent Application No. 10-2006-0102148, filed on Oct. 20, 2006, the disclosure of which is incorporated herein by reference in its entirety.

### BACKGROUND OF THE INVENTION

1. Technical Field

The present disclosure relates to a liquid crystal display including a backlight unit, and more particularly, to a liquid crystal display including a backlight unit having a light source unit including improvements for mounting light emitting diodes on a printed circuit board.

2. Discussion of the Related Art

Surface mounting technology for mounting small semiconductor chips has been used. For example, flexible printed circuit boards, which can be mounted in a limited space, have been used. The flexible printed circuit boards have been used in display devices such as liquid crystal displays (LCDs) or plasma display panels (PDPs).

A backlight unit using light emitting diodes (LEDs) has been used as a light source for a liquid crystal display. The backlight unit using light emitting diodes has smaller power consumption, weight, size, and thickness as compared to a backlight unit using cold cathode fluorescent lamps (CCFLs). The backlight unit using light emitting diodes uses a light emitting diode array as a light source. The light emitting diode array includes a plurality of light emitting diodes arrayed in a line or in a matrix on a substrate. In the light emitting diode array, a flexible printed circuit board can be used as the substrate.

The flexible printed circuit board, which is used in the light emitting diode array, has a structure in which circuit pattern layers are formed on both surfaces of an insulating film. The light emitting diodes are mounted on a circuit pattern layer formed on the upper surface of the flexible printed circuit board. A circuit pattern layer, which includes power wires and various control signal wires, is formed on the lower surface of the flexible printed circuit board. A reinforcing plate may be formed on the lower surface of the flexible printed circuit board.

The light emitting diode array having the above-mentioned structure is formed on the lower side of the backlight unit by using, for example, adhesive tapes. The flexible printed circuit board does not include a structure for providing a ground connection. Accordingly, when the light emitting diodes are quickly turned on and off to reduce power consumption, magnetic fields generated from the light emitting diodes affect the liquid crystals of the liquid crystal panel. Thus, wavy noises may appear on a screen. In addition, known flexible printed circuit boards may have poor heat radiating characteristics, thereby reducing the life span of the light emitting diode.

### SUMMARY OF THE INVENTION

A printed circuit board according to embodiments of the present invention provides improved heat dissipation characteristics and a structure providing a ground connection.

According to an embodiment of the present invention, a backlight unit includes a printed circuit board, and a light source unit including light emitting diodes mounted on a first surface of the printed circuit board, wherein the printed circuit board includes a conductive plate provided on a second surface of the printed circuit board, and a plurality of conductive particles are provided on the conductive plate.

The printed circuit board may be a flexible printed circuit board that includes an insulating film, a first circuit pattern layer provided on a first surface of the insulating film, a second circuit pattern layer provided on a second surface of the insulating film, and a lower coverlay provided on the second circuit pattern layer.

The conductive plate may be provided on the lower coverlay.

The printed circuit board may further include through holes that are formed through the insulating film and connect the first circuit pattern layer with the second circuit pattern layer.

The printed circuit board may further include a binder that is applied on the conductive plate to attach the plurality of conductive particles to the conductive plate.

The printed circuit board may further include an upper coverlay provided on the first circuit pattern layer.

Each of the first and second circuit pattern layers may include a copper foil layer and a plating layer. Further, the plating layer may be provided on the copper foil layer and the through holes.

The second circuit pattern layer may include power wires and control signal wires.

According to an embodiment of the present invention, a liquid crystal display includes a light source unit including a printed circuit board and light emitting diodes mounted on a first surface of the printed circuit board, a plurality of optical sheets provided on the light source unit, a mold frame in which the light source unit and the plurality of optical sheets are received, a liquid crystal panel provided on the plurality of optical sheets, and a lower receiving member that is united with the mold frame and is provided below the light source unit, wherein the printed circuit board includes a conductive plate provided on a second surface of the printed circuit board and a plurality of conductive particles provided on the conductive plate.

The plurality of conductive particles of the printed circuit board may come in contact with the lower receiving member so as to form a ground structure.

According to an embodiment of the present invention, a liquid crystal display includes a light source unit including a printed circuit board and light emitting diodes mounted on a first surface of the printed circuit board, a light guide plate provided on one side of the light source unit, a plurality of optical sheets provided on the light guide plate, a mold frame in which the light source unit and the plurality of optical sheets, a liquid crystal panel provided on the plurality of optical sheets, and a heat radiating plate that is united with the mold frame and is provided below the light source unit and the light guide plate, wherein the printed circuit board includes a conductive plate provided on a second surface of the printed circuit board and a plurality of conductive particles provided on the conductive plate.

The plurality of conductive particles of the printed circuit board may contact the heat radiating plate so as to form a ground structure.

The printed circuit board may be a flexible printed circuit board that includes an insulating film, a first circuit pattern layer provided on a first surface of the insulating film, a second circuit pattern layer provided on a second surface of the insulating film, and a lower coverlay provided on the second circuit pattern layer.

According to an embodiment of the present invention, a method of manufacturing a light source unit includes preparing an insulating film of which both surfaces are covered with copper foil layers, forming through holes through the insulating film, forming a plating layer on the copper foil layer and the through holes, forming a photosensitive film on the plating layer and exposing and developing the photosensitive film, forming first and second circuit pattern layers on the insulating film by etching the copper foil layer and plating layer, forming a lower coverlay on the second circuit pattern layer, forming a conductive plate on the lower coverlay, applying binder on the conductive plate, and attaching a plurality of conductive particles to the binder, and mounting light emitting diodes on the first circuit pattern layer.

### BRIEF DESCRIPTION OF THE DRAWINGS

Exemplary embodiments of the present invention can be understood in more detail from the following description taken in conjunction with the accompanying drawings in which:

FIG. 1 is a schematic perspective view of a flexible printed circuit board according to an embodiment of the present invention;

FIG. 2 is a schematic cross-sectional view of a flexible printed circuit board taken along the line I-I of FIG. 1;

FIGS. 3A to 31 are cross-sectional views illustrating a method of a flexible printed circuit board according to an embodiment of the present invention;

FIG. 4A is a perspective view of a light source unit in which light emitting diodes are mounted on a printed circuit board according to an embodiment of the present invention;

FIG. 4B is a perspective view of a light source unit in which light emitting diodes are mounted on a printed circuit board according to an embodiment of the present invention;

FIG. 5 is a perspective view of a liquid crystal display according to an embodiment of the present invention;

FIG. 6 is a perspective view of a liquid crystal display according to an embodiment of the present invention; and

FIG. 7 is a cross-sectional view of the liquid crystal display taken along the line II-II of FIG. 6.

### DESCRIPTION OF EXEMPLARY EMBODIMENTS

Exemplary embodiments of the present invention will be understood below in more detail with reference to the accompanying drawings. The present invention may be embodied in many different forms and should not be construed as limited to the embodiments set forth herein.

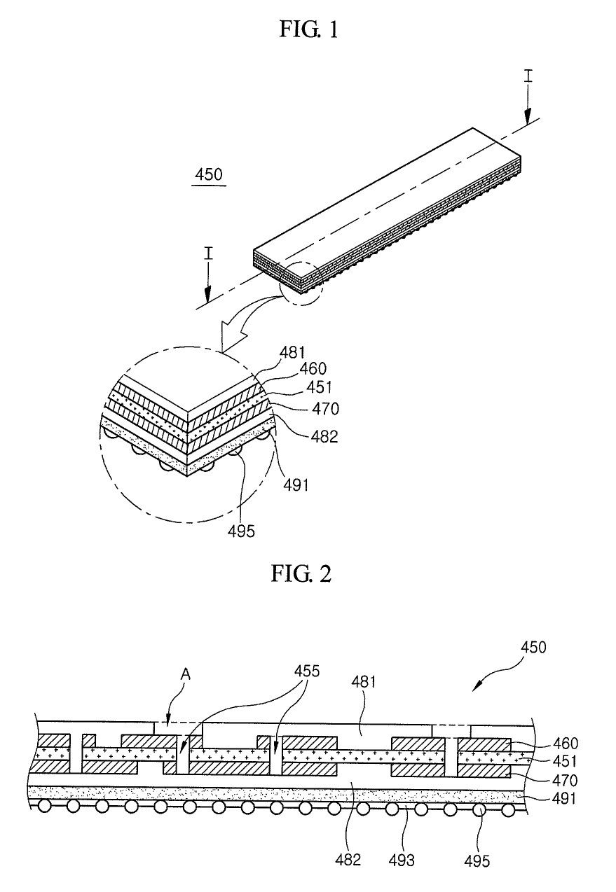

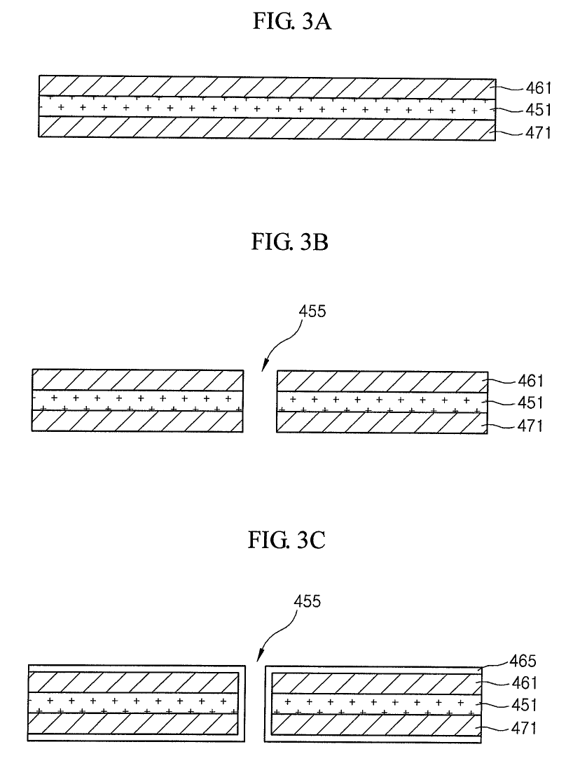

FIG. 1 is a schematic perspective view of a flexible printed circuit board according to an embodiment of the present invention. FIG. 2 is a schematic cross-sectional view of the flexible printed circuit board taken along the line I-I of FIG. 1.

In an embodiment, a printed circuit board includes a base plate on which circuit patterns for mounting light emitting diodes are formed, a conductive plate attached to a first surface of the base plate, and a plurality of conductive particles formed on the conductive plate. In an embodiment, various printed circuit boards, such as a flexible printed circuit board (FPCB), a general printed circuit board (e.g., a rigid printed circuit board), and a metal printed circuit board (PCB), may be used as the printed circuit board.

A flexible printed circuit board according to an embodiment of the present invention is described in FIGS. 1 and 2.

Referring to FIGS. 1 and 2, a flexible printed circuit board 450 includes an insulating film 451, a first circuit pattern layer 460, a second circuit pattern layer 470, an upper coverlay 481, a lower coverlay 482, a conductive plate 491, and a plurality of conductive particles 495.

The first circuit pattern layer 460 including various circuit patterns is formed on a first surface (e.g., an upper surface) of the insulating film 451. The second circuit pattern layer 470 including various circuit patterns is formed on a second surface (e.g., a lower surface) of the insulating film 451. Through holes 455 are formed through the insulating film 451. The through holes 455 electrically connect the first circuit pattern layer 460, which is formed on the first surface of the insulating film 451, with the second circuit pattern layer 470, which is formed on the second surface of the insulating film 451.

In an embodiment, the insulating film 451 may comprise an insulating material, such as polyimide, polyester, glassepoxy, or prepreg. The insulating film 451 can be formed in a shape of, for example, a quadrangular plate, as shown in FIGS. 1 and 2.

The first and second circuit pattern layers 460 and 470 may comprise a copper foil layer (not shown) and a plating layer (not shown), respectively. The plating layer is formed on the copper foil layer and the through holes 455, so that the first circuit pattern layer 460 and second circuit pattern layer 470 are electrically connected with each other.

Various electronic components, such as small chips or light emitting elements, are mounted on the first circuit pattern layer 460 and second circuit pattern layer 470. According to an embodiment, electronic components are mounted in component mounting regions A on the first circuit pattern layer 460.

The upper coverlay 481 is formed on the first circuit pattern layer 460 and the lower coverlay 482 is formed on the second circuit pattern layer 470 so that circuit patterns of the first circuit pattern layer 460 and circuit patterns of the second circuit pattern layer 470 are protected and insulated. In an embodiment, the coverlay 481 is formed in regions except for the component mounting regions A on the first circuit pattern layer 460. The conductive plate 491 is formed on the lower coverlay 482, and a binder 493 is applied on the conductive plate 491. A plurality of conductive particles 495 is provided on the binder 493.

When the conductive plate 491 and the plurality of conductive particles 495 are formed on the lower coverlay 482, it is possible to improve the heat radiating characteristics of the flexible printed circuit board 450. Heat generated from the various electronic components mounted on the first circuit pattern layer 460 or the second circuit pattern layer 470 can be dissipated to the outside through the conductive plate 491 and the plurality of conductive particles 495.

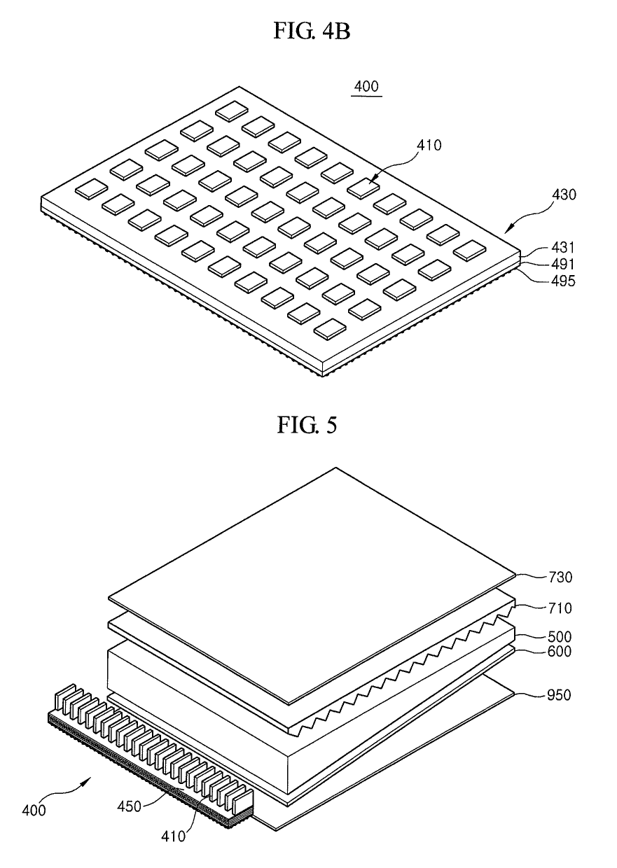

Referring to FIGS. 5, 6 and 7, when the flexible printed circuit board 450 is used, for example, in a liquid crystal display for a notebook PC, the plurality of conductive particles 495 of the flexible printed circuit board 450 contact a first surface of a heat radiating plate 950 to form a structure providing a ground connection. When the flexible printed circuit board 450 is provided in a liquid crystal display for a television, the plurality of conductive particles 495 contact a lower receiving member 900 of the liquid crystal display. The flexible printed circuit board 450 does not contact the lower receiving member 900, and is provided in the lower receiving member 900 with a predetermined space therebetween. As a result, heat can be dissipated by convection and/or conduction. The plurality of conductive particles 495 formed on the conductive plate 491 contact the heat radiating plate 950 or the lower receiving member 900, which comprises, for example, metal, to form a structure providing a ground connection. Thus, it is possible to minimize the effect of electromagnetic waves generated from various electronic components, which are mounted on the first circuit pattern layer 460 or the second circuit pattern layer 470.

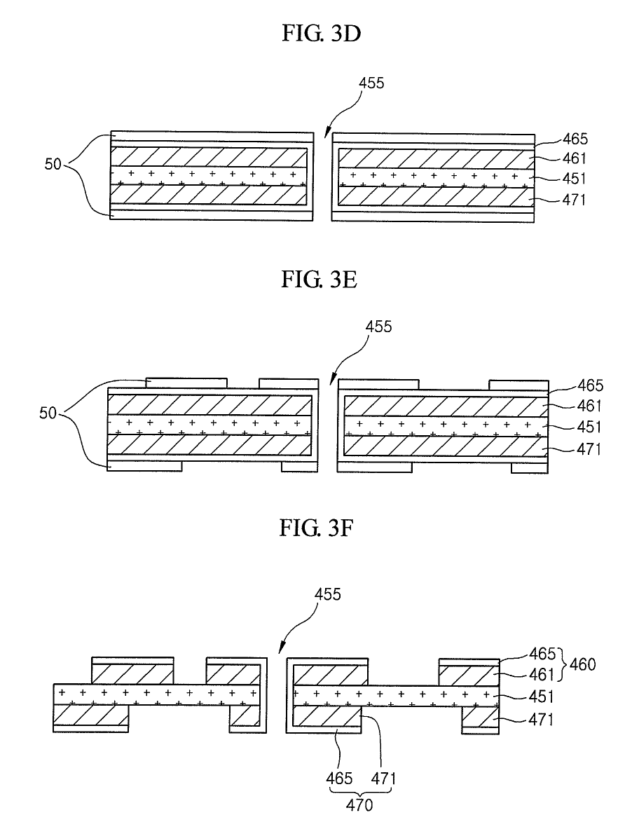

FIGS. 3A to 31 are cross-sectional views illustrating a method of a flexible printed circuit board according to an embodiment of the present invention.

Referring to FIG. 3A, a first copper foil layer 461 is formed on a first surface (e.g., an upper surface) of the insulating film 451, and a second copper foil layer 471 is formed on a second surface (e.g., a lower surface) of the insulating film 451. In an embodiment, the insulating film 451 may comprise an insulating material, such as polyimide, polyester, glassepoxy, or prepreg. The insulating film 451 can be formed, for example, in a quadrangular plate shape.

Referring to FIG. 3B, through holes 455 are formed through the insulating film 451 wherein both surfaces of the insulating film 451 are covered with the first copper foil layer 461 and the second copper foil layer 471. In an embodiment, the through holes 455 are formed using, for example, a drill, such as an NC drill, or laser.

Referring to FIG. 3C, an electroless copper plating process is performed to cause the inner surfaces of the through holes 455 to be conductive. An electrolytic copper plating process is performed, so that a plating layer 465 is formed on the inner surfaces of the through holes 455, the first copper foil layer 461 and second copper foil layer 471.

Referring to FIG. 3D, a photosensitive film 50, for example, a dry film is formed on the plating layer 465. Referring to FIG. 3E, the photosensitive film 50 is exposed by an exposer and the exposed photosensitive film 50 is developed by a developer to form a photosensitive film-mask patterns.

Referring to FIG. 3F, the first copper foil layer 461 and the second copper foil layer 471 are etched by using the photosensitive film-mask patterns, and remaining photosensitive film-mask patterns are removed. A first circuit pattern layer 460 including predetermined circuit patterns and a second circuit pattern layer 470 including predetermined circuit patterns are formed. In an embodiment, the first circuit pattern layer 460 includes the first copper foil layer 461 and the plating layer 465, and the second circuit pattern layer 470 comprises the second copper foil layer 471 and the plating layer 465.

Referring to FIG. 3G, the upper coverlay 481 for protecting the circuit patterns is formed on the first circuit pattern layer 460. In an embodiment, the upper coverlay 481 is formed in regions except for the component mounting regions A on the first circuit pattern layer 460. The lower coverlay 482 for protecting the circuit patterns is formed on the second circuit pattern layer 470. The component mounting regions A are formed only on the first circuit pattern layer 460 in an embodiment of the present invention. Alternatively, the component mounting regions A may be formed on the second circuit pattern layer 470.

Referring to FIG. 3H, the conductive plate 491 is formed on the lower coverlay 482. In an embodiment, the conductive plate 491 may comprise metal such as, for example, copper (Cu). The conductive plate 491 may be formed by attaching thin plates to each other or depositing a metal film.

Referring to FIG. 3H, the binder 493 is applied on the conductive plate 491, and a plurality of conductive particles 495 are provided on the binder 493. In an embodiment, the plurality of conductive particles 495 may comprise metal, and each of the conductive particles 495 can be formed in a spherical shape.

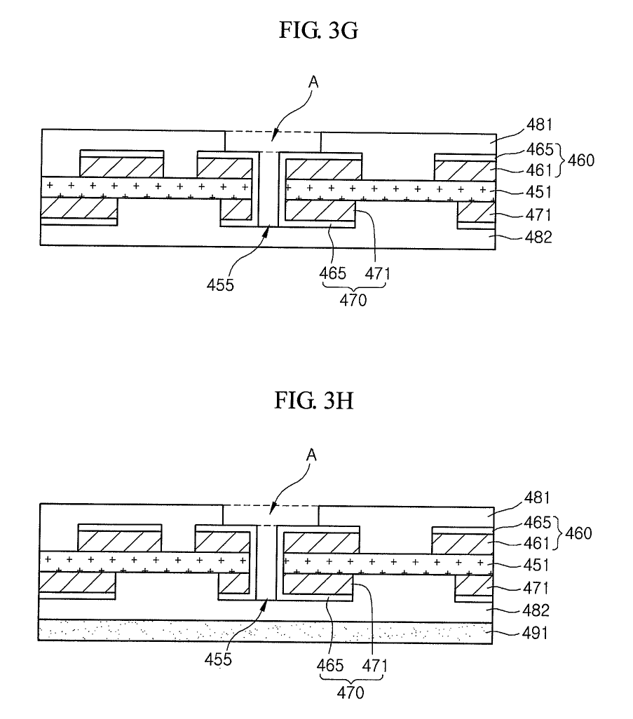

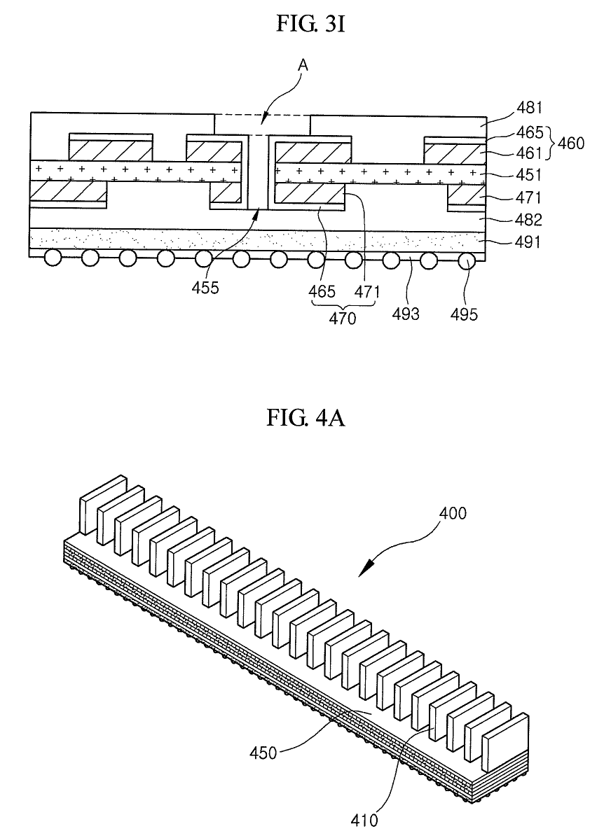

FIG. 4A is a perspective view of a light source unit in which light emitting diodes are mounted on a printed circuit board according to an embodiment of the present invention. FIG. 4B is a perspective view of a light source unit in which light emitting diodes are mounted on a printed circuit board according to an embodiment of the present invention.

Referring to FIG. 4A, a light source unit 400 includes a plurality of light emitting diodes 410. The plurality of light emitting diodes 410 can be arrayed in a line on the flexible printed circuit board 450. The flexible printed circuit board 450 includes the insulating film 451, the first circuit pattern layer 460, the second circuit pattern layer 470, the upper coverlay 481, the lower coverlay 482, the conductive plate 491, and the plurality of conductive particles 495.

The light emitting diodes 410 are mounted on the first circuit pattern layer 460 of the flexible printed circuit board 450. The light emitting diodes 410 are arrayed in a line in an embodiment of the present invention. Alternatively, the array of the light emitting diodes 410 may be arrayed in a matrix.

Referring to FIG. 4B, the light source unit 400 includes a plurality of light emitting diodes 410 arrayed in a matrix on a printed circuit board 430. The printed circuit board 430 includes a base plate 431 on which circuit patterns are formed, the conductive plate 491, and the plurality of conductive particles 495. In an embodiment, the base plate 431 of the printed circuit board 430 may comprise a rigid printed circuit board or metal PCB other than the flexible printed circuit board shown in FIG. 4A.

The light emitting diodes 410 are mounted on the base plate 431. The light emitting diodes 410 can be arrayed, for example, in an M-by-N matrix. In an embodiment, a value of M can be, for example, 5 and a value of N can be, for example, 10.

FIG. 5 is a perspective view of a liquid crystal display according to an embodiment of the present invention. The liquid crystal display shown in FIG. 5 is a liquid crystal display provided with an edge type backlight unit.

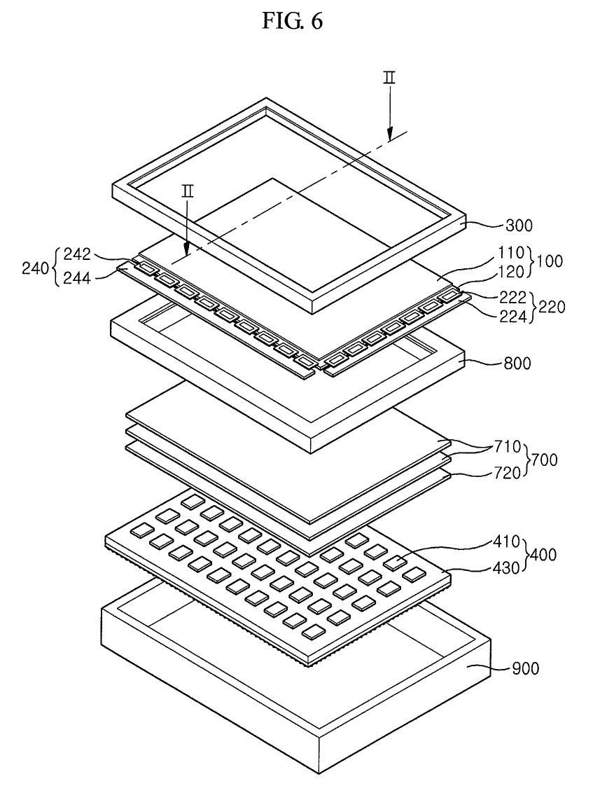

Referring to FIGS. 5 and 6, the liquid crystal display includes a liquid crystal panel (not shown), a driving circuit unit (not shown), a plurality of optical sheets 700, a light source unit 400, a light guide plate 500, a reflective sheet 600, and a heat radiating plate 950.

The light source unit 400 includes the flexible printed circuit board 450 and the plurality of light emitting diodes 410 arrayed in a line on the flexible printed circuit board 450. The light source unit 400 is disposed on a side of the light guide plate 500, and provides light to the light guide plate 500.

The light guide plate 500 converts light having optical distribution corresponding to point light sources into light having optical distribution corresponding to a surface light source.

A prism sheet 710 is disposed on the light guide plate 500, and a protective sheet 730 is disposed on the prism sheet 710. The reflective sheet 600 is disposed below the light guide plate 500, and a sheet having high light reflectance is used as the reflective sheet 600.

The heat radiating plate 950 is disposed below the reflective sheet 600, and the light source unit 400 is disposed on the heat radiating plate 950. In an embodiment, the heat radiating plate 950 may comprise, for example, metal that has high thermal conductivity and high electrical conductivity. The plurality of conductive particles 495 of the flexible printed circuit board 450 contact a first surface of the heat radiating plate 950 to form a structure providing a ground connection. When the light emitting diodes 410 mounted on the flexible printed circuit board 450 are quickly turned on and off, electromagnetic waves or magnetic fields generated from the light emitting diodes 410 are removed by the structure providing a ground connection. As a result, it is possible to prevent wavy noises from appearing on a screen of the liquid crystal panel 100.

Heat generated from the light emitting diodes 410 is conducted to the heat radiating plate 950 through the conductive plate 491 and conductive particles 495 provided below the second circuit pattern layer 470, and is dissipated to the outside. The plurality of conductive particles 495 contact the heat radiating plate 950. The flexible printed circuit board 450 does not contact the lower receiving member 900, and is provided in the lower receiving member 900 with a predetermined space therebetween. As a result, heat can be dissipated by convection as well as the conduction.

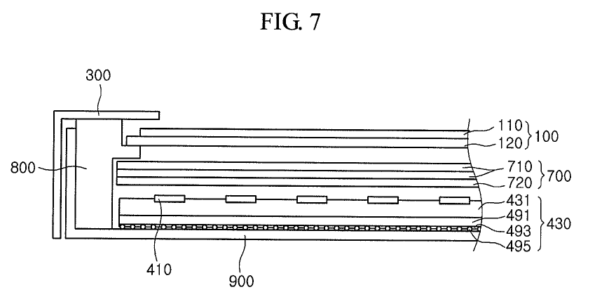

FIG. 6 is a perspective view of a liquid crystal display according to an embodiment of the present invention. FIG. 7 is a cross-sectional view of the liquid crystal display taken along the line II-II of FIG. 6. A liquid crystal display shown in FIGS. 6 and 7 is a liquid crystal display provided with a direct-type backlight unit.

Referring to FIGS. 6 and 7, the liquid crystal display includes an upper receiving member 300, a liquid crystal panel 100, driving circuit units 220 and 240, a plurality of optical sheets 700, a light source unit 400, a mold frame 800, and a lower receiving member 900.

A predetermined receiving space is formed in the mold frame 800, and the plurality of optical sheets 700 and the light source unit 400 are disposed in the receiving space of the mold frame 800 to form the backlight unit. A liquid crystal panel 100 for displaying images is disposed above the backlight unit.

The driving circuit unit 220 includes a gate printed circuit board 224 and a flexible gate printed circuit board 222, and the driving circuit unit 240 includes a flexible data printed circuit board 242 and a data printed circuit board 244. The gate printed circuit board 224 is connected to the liquid crystal panel 100, includes control integrated circuits (ICs) mounted thereon, and supplies predetermined gate signals to gate lines of a TFT substrate 120. The data printed circuit board 244 includes control ICs mounted thereon, and supplies predetermined data signals to data lines of the TFT substrate 120. The flexible gate printed circuit board 222 connects the TFT substrate 120 with the gate printed circuit board 224, and the flexible data printed circuit board 242 connects the TFT substrate 120 with the data printed circuit board 244. Each of the flexible printed circuit boards 222 and 242 includes a driving IC mounted thereon.

The flexible printed circuit boards 222 and 242 transmit Red, Green, and Blue (RGB) signals and digital power, which are generated from the printed circuit boards 224 and 244, to the liquid crystal panel 100.

The plurality of optical sheets 700 includes a diffuse plate 720, and first and second prism sheets 710. Since the diffuse plate 720 diffuses the light incident from the light source unit 400, the diffuse plate 720 can prevent a partial concentration of light and reduce an angle between the first prism sheet and light entering the first prism sheet. Prisms having a triangular cross-section are arrayed in regular patterns on the upper surface of each of the first and second prism sheets 710, and the first and second prism sheets 710 are disposed so that the prisms of the first and second prism sheets 710 alternate with each other. The first and second prism sheets 710 concentrate the light, which is diffused by the diffuse plate 720, in a direction perpendicular to the liquid crystal panel 100. Two prism sheets are used in an embodiment of the present invention.

The upper receiving member 300 is combined with the mold frame 800 to cover edge portions (e.g., non-display regions) of the liquid crystal panel 100 and side and lower surfaces of the mold frame 800. The lower receiving member 900 is provided below the mold frame 800, and closes the receiving space of the mold frame 800.

Referring to FIG. 7, the light source unit 400 includes the printed circuit board 430, and the plurality of light emitting diodes 410 arrayed in a matrix on the printed circuit board 430. The conductive plate 491, the binder 493 applied on the conductive plate 491, and the plurality of conductive particles 495 are formed on a second surface of the printed circuit board 430.

Referring to FIGS. 1 to 3 and 7, the light emitting diodes 410 may be mounted on the flexible printed circuit board 450. In an embodiment, the flexible printed circuit board 450 includes an insulating film 451, first and second circuit pattern layers 460, 470 formed on the respective upper and lower surfaces of the insulating film 451, the upper coverlay 481 formed on the first circuit pattern layer 460, a lower coverlay 482 formed on the second circuit pattern layer 470, the conductive plate 491 formed on the lower coverlay 482, and the binder 493 and the plurality of conductive particles 495 which are applied on the conductive plate 491. In an embodiment, the light emitting diodes 410 are mounted in the first circuit pattern layer 460. The second circuit pattern layer 470 includes, for example, power wires and control signal wires. Power is supplied to the light emitting diodes 410 through the power wires, and control signals for controlling the driving of the light emitting diodes 410 are transmitted to the control signal wires.

The light source unit 400 is disposed on the lower receiving member 900. Accordingly, the plurality of conductive particles 495 of the printed circuit board 430 contact the lower receiving member 900 to form a structure providing a ground connection. When the light emitting diodes 410 mounted on the printed circuit board 430 are quickly turned on and off, electromagnetic waves or magnetic fields generated from the light emitting diodes 410 are removed by the structure providing a ground connection. As a result, it is possible to prevent wavy noises from appearing on a screen of the liquid crystal panel 100.

Heat generated from the light emitting diodes 410 is conducted to the lower receiving member 900 through the conductive plate 491 and conductive particles 495, which are provided below the base plate 431 of the printed circuit board 430, and is dissipated to the outside. The plurality of conductive particles 495 contact the lower receiving member 900 of the liquid crystal display. The printed circuit board 430 does not contact the lower receiving member 900, and is provided in the lower receiving member 900 with a predetermined space therebetween. As a result, heat can be dissipated by convection as well as conduction.

According to embodiments of the present invention, the light emitting diodes 410 may be mounted on various printed circuit boards, which include a conductive plate and conductive particles. The printed circuit boards may include a flexible printed circuit board, a metal PCB, or a general printed circuit board.

According to embodiments of the present invention, since a conductive plate is attached to a first surface of a printed circuit board and conductive particles are attached on the conductive plate, it is possible to improve the heat radiating characteristic of a printed circuit board.

Conductive particles of a printed circuit board are connected with a metal member, which can be a heat radiating plate or a lower receiving member to form a structure providing a ground connection. Since it is possible to reduce a magnetic field having an effect on a liquid crystal panel, image quality of the liquid crystal display can be improved.

Although exemplary embodiments have been described with reference to the accompanying drawings, it is to be understood that the present invention is not limited to these precise embodiments, but various changes and modifications can be made by one skilled in the art without departing from the spirit and scope of the present invention. All such changes and modifications are intended to be included within the scope of the invention as defined by the appended claims.

What is claimed is:

1. A backlight unit comprising:
a printed circuit board; and
light emitting diodes mounted on a first surface of the printed circuit board,
wherein the printed circuit board includes a conductive plate provided on a second surface of the printed circuit board, and a plurality of conductive particles are provided on the conductive plate.

2. The backlight unit of claim 1, wherein the printed circuit board comprises a flexible printed circuit board.

3. The backlight unit of claim 2, wherein the flexible printed circuit board includes an insulating film, a first circuit pattern layer provided on a first surface of the insulating film, a second circuit pattern layer provided on a second surface of the insulating film, and a lower coverlay provided on the second circuit pattern layer.

4. The backlight unit of claim 3, wherein the conductive plate is provided on the lower coverlay.

5. The backlight unit of claim 3, wherein the printed circuit board further includes through holes formed through the insulating film, and the through holes connect the first circuit pattern layer with the second circuit pattern layer.

6. The backlight unit of claim 3, wherein the printed circuit board further includes a binder applied on the conductive plate to attach the plurality of conductive particles to the conductive plate.

7. The backlight unit of claim 3, wherein the printed circuit board further includes an upper coverlay provided on the first circuit pattern layer.

8. The backlight unit of claim 5, wherein each of the first and second circuit pattern layers includes a copper foil layer and a plating layer, and
the plating layer is provided on the copper foil layer and the through holes.

9. The backlight unit of claim 3, wherein the second circuit pattern layer includes power wires and control signal wires.

10. The backlight unit of claim 1, further comprising:
a plurality of optical sheets provided on the light source unit; and
a mold frame in which the light source unit and the plurality of optical sheets are received.

11. A liquid crystal display comprising:
a light source unit including a printed circuit board and light emitting diodes mounted on a first surface of the printed circuit board;
a plurality of optical sheets provided on the light source unit;
a mold frame receiving the light source unit and the plurality of optical sheets;
a liquid crystal panel provided on the plurality of optical sheets; and
a lower receiving member receiving the mold frame, the lower receiving member provided behind the light source unit,
wherein the printed circuit board includes a conductive plate provided on a second surface of the printed circuit board and a plurality of conductive particles provided on the conductive plate.

12. The liquid crystal display of claim 11, wherein the plurality of conductive particles of the printed circuit board contact the lower receiving member.

13. The liquid crystal display of claim 11, further comprising:
a light guide plate provided on a side of the light source unit; and
a heat radiating plate combined with the mold frame, the heat radiating plate provided behind the light source unit and the light guide plate.

14. The liquid crystal display of claim 13, wherein the plurality of conductive particles of the printed circuit board contact the heat radiating plate.

15. The liquid crystal display of claim 13, wherein the printed circuit board comprises a flexible printed circuit board.

16. The liquid crystal display of claim 15, wherein the flexible printed circuit board includes an insulating film, a first circuit pattern layer provided on a first surface of the insulating film, a second circuit pattern layer provided on a second surface of the insulating film, and a lower coverlay provided on the second circuit pattern layer.

17. A method of manufacturing a light source unit, the method comprising:
preparing an insulating film having copper foil layers on two surfaces of the insulating film;
forming through holes through the insulating film;
forming a plating layer on the copper foil layers and the through holes;
forming a photosensitive film on the plating layer and exposing and developing the photosensitive film;
forming first and second circuit pattern layers on the insulating film by etching the copper foil layers and the plating layer;
forming a lower coverlay on the second circuit pattern layer;
forming a conductive plate on the lower coverlay;
applying a binder on the conductive plate, and attaching a plurality of conductive particles to the binder; and
mounting light emitting diodes on the first circuit pattern layer.

18. The method of claim 17, further comprising forming an upper coverlay on the first circuit pattern layer.
